(19) United States
(12) Patent Application Publication
(10) Pub. No.: US 2019/0357500 A1
(43) Pub. Date: Nov. 28, 2019

(54) SMALL-SIZED INCUBATOR

(71) Applicants: Vladyslav Elikovych VITVYTS'KYY, Kyiv (UA); Hrystyna Vasylivna GUMENIUK, Bilgorod-Dnistrovs'kyy (UA)

(72) Inventors: Vladyslav Elikovych VITVYTS'KYY, Kyiv (UA); Hrystyna Vasylivna GUMENIUK, Bilgorod-Dnistrovs'kyy (UA)

(21) Appl. No.: 16/483,769

(22) PCT Filed: Feb. 14, 2018
(86) PCT No.: PCT/UA2018/000009

§ 371 Date: Aug. 6, 2019

(30) Foreign Application Priority Data
Feb. 17, 2017 (UA) A 2017 01496

(51) Int. Cl. A01K 41/02; A01K 41/04; A01K 41/06; G05D 23/20

(52) U.S. Cl. CPC A01K 41/023; G05D 23/20; A01K 41/06; A01K 41/04

(57) ABSTRACT

The invention relates to household appliances intended for agricultural purposes and can be used for the incubation of eggs from any poultry bird at a homestead or a private household as well as in small business or for breeding poultry in small quantities. The small-sized incubator comprises a housing, preferably having the form of a parallelepiped, configured to have a frame structure (1); a heat-insulating cover (4), a heating element (11), a humidifier (13), a fan (14), at least one egg tray configured to rotate eggs, a temperature sensor and a humidity sensor, a control unit configured to be connected to a backup power unit, according to the invention, the said frame housing is configured to be assembled and disassembled with connectors (3); the said heating element is located on or directly above the inner surface of the heat-insulating cover; the incubator is equipped with an emergency fan (15) located on the top of the housing. Further, for another embodiment of the small-sized incubator which differs from the first one in that the humidifier is configured to be a high frequency membrane equipped with a reflector, which, according to yet another feature of the invention claimed, is located above the membrane at an angle from 30° to 60° to the membrane. The application of the present invention allows us to create an energy-efficient small-sized incubator with highly-reliable operation in a given range of air temperature and humidity by positioning heating, ventilation and humidification elements in the design of the incubator and, at the same time, by improving the ease of its operation and providing an opportunity for thorough cleaning by configuring the housing and the heat-insulating cover of the incubator so that the said elements are made assemblable and disassemblable.

The invention relates to household appliances intended for agricultural purposes and can be used for the incubation of eggs from any poultry bird at a homestead or a private household as well as in small business or for breeding poultry in small quantities.

To date, there are many types of incubators serving industrial needs and intended for large-scale poultry breeding as well as small-sized incubators intended for private households, farms, small businesses and breeding poultry in small quantities. The small-sized configuration of such incubators helps to simplify elements of the design, which in most cases affects the overall reliability of maintaining temperature and humidity conditions and energy efficiency of an incubator. That is why there is a need to create a small-sized incubator which would be easy-to-use and easy-to-transport and which would provide the required air temperature and humidity conditions for egg hatching. The incubator disclosed herein can be repeatedly used in poultry farming to obtain the expected technical result.

Many similar small-sized incubators are known including those described below and considered the closest prior art based on the set of essential features.

The prior art describes small-sized incubators according to patents: RU133386 published on Oct. 10, 2013, RU2049387 published on Dec. 10, 1995, and U.S. Pat. No. 1,943,575 published on Jan. 16, 1934 having the following common features: a chamber containing egg trays, rotatable egg trays, heating elements, fans, humidifiers and an incubator control unit. The said closest prior art is characterized by the availability of standard design elements essential for the operation of an incubator. However, the positioning and configuration of those elements in the design of an incubator does not provide conditions which would be most favorable for poultry breeding. Further, for example, the use of incandescent lamps as a heating element causes uneven heating of eggs with an over-/underheated incubation areas of the incubator where an egg tray can be located, especially during the second half of the incubation period. Further, the configurations of incubators according to the said closest prior art do not provide an opportunity for thorough cleaning and do not contribute to overall ease of transportation and operation.

The prior art also describes small-sized incubators according to the references: https://tgb280.jimdo.com/% D0%B8%D0%BD %D0%BA %D1%83%D0%B1%D0% B0%D1%82%D0%BE %D1%80-%D1%82%D0%B3%D0%B1/and https://ru.aliexpress.com/item/Digital-commercial-thermostat-incubator-with-competitive-price-96-egg-incubator/32469162448.html?spm=2114.10010208.1000014.10.9iisLI&scm=1007.13338 0.49930.0&pvid=c1 f5262d-3dba-404b-83 f8-d769fe12635a&tpp=1&detailNewVersion=&categoryId=200003752. The said closest prior art is characterized by a simplified design and ease of use. However, the positioning of main heating, ventilation and humidification elements in the design of the said incubators does not allow for precise regulation and reliable maintenance of temperature and humidity conditions as recommended by those skilled in the art of poultry egg incubation.

The small-sized incubator according to patent RU2028779 published on Feb. 20, 1995, comprising a housing, egg trays installed in the housing, an egg rotation means connected to a drive, and a heating and humidity maintenance system, is taken as a prototype for the present invention. The housing has a heat-insulating frame wherein egg trays are installed, and the said egg rotation means is configured to form rollers mounted on egg trays configured to rotate on their axis, with one roller of each egg tray being connected to the drive, while the other rollers of that tray are connected to the roller coupled with the drive using coupling elements.

The positioning of the main heating, ventilation and humidification elements in the design of the said incubator does not provide the required energy-efficient operation of the said small-sized incubator under the given air temperature and humidity conditions. Further, such configuration of the incubator does not provide an opportunity for thorough cleaning and does not contribute to overall ease of transportation and ease of operation.

The prior art describes many technical solutions modifying the design of incubators to improve the operation of its individual units without modifying the overall design thereof. However, those technical solutions are inefficient in solving the said problem.

The task of this invention is to create an energy-efficient small-sized incubator which provides highly-reliable operation under the given air temperature and humidity conditions by positioning the heating, ventilation and humidification elements in the design of the incubator and, at the same time, by improving the ease of operation and cleaning of inner surfaces of the incubator by configuring the housing and the heat-insulating cover of the incubator so that the said elements are made assemblable and disassemblable.

The task is achieved in that the small-sized incubator comprises a housing, preferably having the form of a parallelepiped, configured to have a frame structure; a heat-insulating cover, a heating element, a humidifier, a fan, at least one egg tray configured to rotate eggs, a temperature sensor and a humidity sensor, a control unit configured to be connected to a backup power unit, according to the invention, the said frame housing is configured to be assembled and disassembled with connectors; the said heating element is located on or directly above the inner surface of the heat-insulating cover; the incubator is equipped with an emergency fan located on the top of the housing.

The said heating element can be positioned in the upper and/or side parts of the housing.

Further, the heating element can be configured so that heating capacity can be changed.

Further, the heating element can be configured to form a heating mat.

In this case, the axis of the fan can be located at a distance of up to 0.5 of the height of the incubator from the lower inner surface of the heat-insulating cover.

The fan can be equipped with a diffuser located directly above the humidifier.

The said small-sized incubator can be equipped with an additional fan located on a wall of the frame housing that is opposite the fan with a diffuser.

Further, the small-sized incubator can be equipped with ventilation openings located on the heat-insulating cover.

Also the task is achieved in that the small-sized incubator comprises a housing, preferably having the form of a parallelepiped, configured to form a frame structure; a heat-insulating cover, a heating element, a humidifier, a fan, at least one egg tray configured to rotate eggs, a temperature sensor and a humidity sensor, a control unit configured to be connected to a backup power source, according to the invention, the said frame housing is configured to be assembled and disassembled with connectors, with the said heating element being placed on or directly above the inner surface of the heat-insulating cover and the humidifier being configured to be a high-frequency membrane equipped with a reflector.

The said reflector can be located above the membrane at an angle of 30° to 60° to the membrane.

The said heating element can be positioned in the upper and/or side parts of the housing.

Further, the heating element can be configured to change the heating capacity.

Further, the heating element can be configured to form a heating mat.

The axis of the fan can be located at a distance of up to 0.5 of the height of the incubator from the lower inner surface of the heat-insulating cover.

The fan can be equipped with a diffuser located directly above the humidifier.

The said small-sized incubator is equipped with an emergency fan located in the upper part of the housing.

The said small-sized incubator can further be equipped with an additional fan located on a wall of the frame housing opposite the fan with a diffuser.

Further, the small-sized incubator can be equipped with ventilation openings located on a heat-insulating cover.

The causal relationship between the set of essential features of the present invention and the technical result achieved with the use thereof is described below.

According to one feature of the invention disclosed herein, the small-sized incubator comprises a frame housing configured to be assembled and disassembled with connectors. Such configuration of the housing helps to improve both ease of operation and ease of transportation and to substantially reduce costs for the transportation of an unassembled incubator, to reduce labor efforts when the incubator is used, to increase its mobility, to provide an opportunity to change the number of eggs intended for hatching per release by adding or removing assemblable and disassemblable elements of the frame housing. Further, such configuration allows us to provide one of the important incubation processes—quick and thorough cleaning of the disassembled incubator. The efficiency of the use of the assemblable and disassemblable frame housing depends on the reliability of connectors.

The compact assemblable and disassemblable design facilitates the assembly and transportation of the incubator and helps to reduce the overall dimensions of the incubator as confirmed by the tests completed by the inventors and shown in Table 1 below. A small-sized incubator (as shown by reference: https://tgb280.jimdo.com/%D0%B8%D0%BD %D0%BA %D1%83%D0%B1%D0% b0%D1%82%D0%BE %D1%80-%D1%82%D0%B3%D0%B1/) was considered as the closest prior art in terms of the egg hatching capacity.

TABLE 1
Comparative table of the weight and volume of the
small-sized incubator disclosed herein and the
small-sized incubator known in the prior art

| | | | | | Closest (in terms of | |
|---|---|---|---|---|---|---|
| | Disassembled | | Assembled | | egg hatching | |
| | housing of the | | housing of the | | capacity) small- | |
| | small-sized | | small-sized | | sized incubator | |
| | incubator disclosed | | incubator disclosed | | known in the prior | |
| | herein | | herein | | art | |
| | Weight, | Volume, | Weight, | Volume, | Weight, | Volume, |
| | kg | m³ | kg | m³ | kg | m³ |
| | 12 | 0.0712 | 12 | 0.1775 | 13 | 0.216 |
| Per | 0.071 | 0.0004 | 0.071 | 0.00104 | 0.76 | 0.00127 |
| hatcher | | | | | | |
| place | | | | | | |

The volume of the incubator disclosed herein and the one known in the art and considered to be the closest prior art in terms of egg hatching capacity were taken as baseline data for analysis. The average egg hatching capacity of incubators available in this market segment is 150 to 200 eggs. Since the incubators practically do not vary by weight, the volume of the incubator with disassembled housing is 0.0004 m³ vs. 0.00127 m³ of the assembled one proving that the former is easier in operation and transportation.

According to one feature of the invention disclosed herein, the heating element of the incubator is located on or directly above the inner surface of the heat-insulating cover. The heating element thus located allows for reliable maintenance of the pre-set temperatures within the incubator. Further, according to a feature of the invention disclosed herein, the location of the heating element in the upper and/or side parts of the housing allows for the most even distribution of temperature within the area of egg trays and maximum heat output, as warm air has enough time to mix up with cold air coming through ventilation openings. An optimal location of the heating element, in particular on two sidewalls and the upper wall of the frame housing of the incubator, was determined through practical and experimental tests.

According to another feature of the invention disclosed herein, the heating element is configured so that the heating capacity can be changed. The configuration of the heating element so that its heating capacity can be changed allows for uniform heating inside the incubator and efficient regulation of temperatures required for different climatic zones of operation and different stages of incubation and for eggs requiring various temperature conditions for incubation. An actual deviation of temperatures within the small-sized incubator at various points therein does not exceed the recommended value, i.e. +/−0.5° C.

Further, according to yet another feature of the invention disclosed herein, the heating element is configured to form a heating mat with a heating cable placed along the area thereof. The configuration of the heating element in the form of a heating mat, first of all, allows us to turn the heating element into a distributed heat source, and the surface of the heating mat evenly sends out heat. The configuration of the heating element in the form of a heating mat helps to prevent a heat shock (a short-term rise in the temperature critical for incubation) common for other types of heating elements (such as lamps or heating coils). Further, the efficiency of using a heating mat is that it is the most optimal option for creating an inexpensive and efficient heating system.

A set of experiments was conducted to determine the optimal location of the heating mat. The experiments used basic parameters such as density of placing a heating cable on the upper part and side parts of the housing and temperature distribution in various areas of the present invention, in particular within the lower, middle and upper parts of the incubator. The additional data used in the analysis include the time of air heating inside the incubator to a given temperature. The temperature at 38.0° C. and humidity at 70% inside the incubator were taken as baseline parameters for testing. The tests were done as indoor tests at a room temperature with the incubator operating at its full capacity and with the main elements of the invention, such as a heating mat, a humidifier, and a diffuser, switched on. The achievement of the desired result, in particular the reliable maintenance of temperature and humidity conditions, is affected by all elements. Table 2 below shows three test options with the test results closest to the above values.

Based on the given parameters and the obtained results, the inventors determined during their tests that the location of the heating mat on two sidewalls and the upper wall of the frame housing of the incubator with the density of cable placement in the heating mat within the range of 10.00 . . . 12.00 m/m² allows the inventors to achieve a temperature deviation in various areas of the incubator at up to 0.4° C. The temperature stabilization is achieved within the first 1.5 hours after the incubator is switched on.

Thus, the tests completed by the inventors show that the location of the heating mat on at least one or two sidewalls and on the upper wall of the frame housing of the incubator provides not only the required temperature and humidity conditions for egg incubation but also a highly reliable operation of the incubator.

According to one feature of the invention disclosed herein, the incubator is equipped with an emergency fan located in the upper part of the housing. It is known that eggs substantially increase heat production during final days of hatching. Eggs themselves produce heat during the incubation process, so adjacent eggs warm each other. The configuration of the incubator with an emergency fan helps to maintain the temperature conditions in the internal cavity of the incubator if a temperature rises above the acceptable value. If this occurs, the emergency fan automatically cools air within the incubator by blowing overheated air out. The emergency fan also provides the function of regular forced air conditioning. As part of the egg hatching process, it is recommended to ventilate the incubator in the middle and during the second half of the incubation process. When the air conditioning mode is switched on automatically, the heating mode is switched off, so air could be completely blown out of the incubator and eggs could be cooled to a specific temperature.

TABLE 2
Mean temperature deviations depending on location of a heating mat

| | Location of the heating element | | | | | | |
|---|---|---|---|---|---|---|---|
| | | Time of | Temperature distribution by area of the incubator | | | | |
| | Density of | heating to a | Sensor 1, | Sensor 2, | Sensor 3, | | |
| Test | heating cable | pre-set | lower part | middle part | upper part | | |
| option | placement, | temperature. | of the | of the | of the | | |
| No. | m/m² | min. | incubator | incubator | incubator | Delta | Delta |

| | | | | | |
|---|---|---|---|---|---|
| Option 1 | 10.00 . . . 12.00 | 19 | t value during the 1^{st} hour of operation, ° C. | 1.0 | 0.8 |

| 38.4 | 37.4 | 38.0 | |
|---|---|---|---|
| t value during the 2^{nd} hour of operation, ° C. | | | 1.0 |
| 38.1 | 37.3 | 37.1 | |
| t value during the 5^{th} hour of operation, ° C. | | | 0.4 |
| 38.0 | 37.6 | 37.8 | |

| | | | | | |
|---|---|---|---|---|---|
| Option 2 | 8.00 . . . 10.00 | 21 | t value during the 1^{st} hour of operation, ° C. | 1.3 | 1.1 |

| 36.5 | 37.8 | 37.5 | |
|---|---|---|---|
| t value during the 2^{nd} hour of operation, ° C. | | | 1.1 |
| 36.8 | 37.9 | 37.5 | |
| t value during the 5^{th} hour of operation, ° C. | | | 0.8 |
| 37.3 | 37.9 | 37.5 | |

| | | | | | |
|---|---|---|---|---|---|
| Option 3 | 14.00 . . . 16.00 | 24 | t value during the 1^{st} hour of operation, ° C. | 3.5 | 2.6 |

| 35.7 | 38.3 | 39.2 | |
|---|---|---|---|
| t value during the 2^{nd} hour of operation, ° C. | | | 2.3 |
| 36.2 | 38.0 | 38.5 | |
| t value during the 5^{th} hour of operation, ° C. | | | 2.0 |
| 36.3 | 38.0 | 38.3 | |

The location of the emergency fan in the upper part of the housing allows for maximum removal of overheated air concentrated in the upper part of the incubator. Thus, the emergency fan performs both the ventilating function and the emergency cooling function. The operation of the emergency fan prevents overheating of eggs and thereby improves the reliable operation of the incubator.

According to one feature of the invention disclosed herein, the axis of the fan is located at a distance of up to 0.5 of the height of the incubator from the lower inner surface of the heat-insulating cover. The examinations and simulation tests completed by inventors showed that such positioning of the fan allows for gentle and uniform heating of the entire volume of the incubator.

The studies tested more than six options for the location of the fan. Table 3 below demonstrates the main test options varying by the location of the axis of the fan, where in Option 1 the axis of the fan is located within the range of 25 . . . 35, in particular at a height of the incubator of 30 cm from the lower inner surface of the heat-insulating cover, in Option 2 the axis of the fan is located within the range of 35 . . . 45, in particular at a height of 40 cm, and in Option 3 the axis of the fan is located within the range of 45 . . . 55, in particular at a height of 50 cm. The temperature at 38.0° C. and humidity at 90% inside the incubator were taken as baseline parameters for testing.

TABLE 3
Distribution of temperature and humidity
depending on the location of the fan

| | | Temperature distribution by area of | | | |
|---|---|---|---|---|---|
| | | the incubator | | | |
| | | Sensor 1, | Sensor 2, | Sensor 3, | |
| Test | | lower part | middle part | upper part | |
| option | Humidity, | of the | of the | of the | |
| number | % | incubator | incubator | incubator | Delta |
| Option 1 | 71.0 | 37.0 | 37.8 | 39.6 | 2.6 |
| Option 2 | 89.6 | 37.6 | 38.1 | 37.6 | 0.5 |
| Option 3 | 89.1 | 37.7 | 37.7 | 36.8 | 1.1 |

Based on the data obtained during the testing and shown in Table 3 above, the values in Option 1 and Option 3 do not achieve the pre-set humidity value of 90% and the pre-set temperature, while Option 2 demonstrates the most optimal and stable temperature and humidity values.

The exminations show that the location of the axis of the fan at a height of 40 cm affects the final difference in the temperature distribution throughout the volume of the incubator. The delta of 0.5° C. is acceptable and optimal for breeding various types of birds under household conditions.

Further, according to yet another feature of the invention disclosed herein, the fan is equipped with a diffuser located directly above the humidifier. The diffuser is configured to be a rectangular channel that shapes and directs airflow coming from the fan. The configuration with the diffuser located directly above the humidifier can improve the distribution of warm air flow, since fresh air coming through inflow ventilation openings and warm air flows coming from the heating mat mix up well before they reach egg trays and provide for the supply of heated air along egg trays, uniform distribution of warm air flow, and maintenance of the same temperature at any point inside the incubator.

According to one feature of the invention disclosed herein, the incubator is equipped with an additional fan located on a wall of the frame housing that is opposite the fan with the diffuser. A drop of an ambient temperature to 10° C. can form a cold air chamber in the lower part of the incubator, below egg trays and the humidifier, so that the uniform distribution of temperature throughout the entire volume of the incubator will be compromised. The availability of an additional fan in the incubator allows the incubator to be used when an ambient temperature drops down while keeping performance of the incubator as high as it is achieved with the operation at a room temperature. This is achieved by placing the additional fan in the lower part of the incubator on a wall of the frame housing that is opposite the fan with the diffuser and thereby ensuring the uniform temperature distribution throughout the entire volume of the incubator through additional mixing of air.

According to one feature of the invention disclosed herein, the incubator is equipped with ventilation openings located on the heat-insulating cover. The configuration of the incubator with ventilation openings on the heat-insulating cover allows for natural convection of air flow inside the incubator. Such openings are through cavities which provide transportation of air masses. First, the incubator receives external oxygen-enriched air. At the same time, due to equalization of pressure and temperature, exhaust air saturated with carbon dioxide comes out of the incubator through openings. Secondly, air inflow and outflow provide internal circulation of air masses. This prevents dead-air areas with high content of carbon dioxide. Thirdly, humidity of the incubator is regulated through ventilation openings. A significant amount of water vapor is removed through ventilation openings and this contributes to the circulation of internal air and prevents the development of fungal infections. This is also supported by the fan with the diffuser located directly above the humidifier.

The number and availability of ventilation openings affects humidity changes inside the incubator. The tests demonstrated that no more than ⅖ of the total area of ventilation openings should be located in the lower part of the incubator, while no less than ⅗ of the total area of ventilation openings should be located opposite the emergency fan. This ratio allows for outflow of exhaust air and, at the same time, provides stable support for temperature and humidity conditions. A greater or lesser ratio of ventilation openings causes unacceptable fluctuations of temperature and humidity conditions.

Examinations have been completed by the inventors. The temperature at 38.0° C. and humidity at 90% were taken as baseline parameters for testing (high humidity is essential for hatching eggs of rare and waterfowl species of birds). As in all tests, temperature was measured in three areas of the incubator. Humidity was measured by a standard humidity measuring sensor placed in the middle part of the incubator, i.e. in an area intended for egg hatching. For the temperature analysis, Table 4 below shows the final differences in test parameters during the five-hour operation of the incubator.

TABLE 4
Dependence of temperature and humidity conditions
from parameters of ventilation openings

| | Total area | | | | |
|---|---|---|---|---|---|
| Test | of the | Total area | Specific | Final | |
| option | incubator, | of openings, | weight, | difference, | Humidity, |
| number | cm² | cm² | % | t, ° C. | % |
| Option 1 | 19,200 | 14.5 | 0.075 | 1.8 | 63 |
| Option 2 | 19,200 | 7.35 | 0.038 | 1.5 | 75 |
| Option 3 | 19,200 | 5.65 | 0.029 | 0.5 | 90 |

The examinations allowed the inventors to determine the optimal correlation of ventilation openings and location thereof, and Table 4 above shows that Option 3 is the most suitable for maintaining the pre-set temperature and humidity values. The humidity and temperature difference achieved in three areas at a level of 0.5° C. allow users (farmers) to hatch any breed of birds. The incubator adjusts the given parameters fully automatically.

The said design of ventilation elements, according to the feature of the invention disclosed herein, specifically a fan with a diffuser, the configuration of the incubator with ventilation openings and an emergency fan, is provided to compensate for heat produced by eggs themselves and to remove carbon dioxide released during the egg incubation process from the incubator. The said location of ventilation elements allows not only to ensure uniform temperature distribution throughout the entire volume of the incubator at given parameters, but also to maintain optimal incubation conditions irrespective of the number and weight of eggs placed in the incubator and the climatic zone where the incubator is operated.

Further, the inventors have provided for another embodiment of the small-sized incubator which differs from the first one in that the humidifier is configured to be a high-frequency membrane equipped with a reflector, which, according to yet another feature of the invention disclosed herein, is located above the membrane at an angle from 30° to 60° to the membrane. Such configuration of the humidifier in the design of the incubator allows for a more efficient distribution of moist air throughout the volume of the incubator.

A number of tests were done using humidifiers of various designs. Operation of a high-frequency membrane is accompanied by water evaporation. Without forced circulation, steam thus produced condenses into water drops at the bottom of the incubator. The resulting so-called water drain at the bottom of the incubator cools the lower part of the incubator and adversely affects temperature and humidity conditions.

The examinations showed that in order to maintain the required level of humidity in a sustained way, it is crucial that the reflector is located over the membrane at an angle within the range from 30° to 60° to the membrane. The design solution was chosen from three configurations of the humidifier. The test results are given in Table 5 below.

TABLE 5
Dependence of temperature and humidity conditions from an
angle of the reflector to the membrane of the humidifier

| | | Temperature distribution by area of the | | | |
|---|---|---|---|---|---|
| | | incubator, ° C. | | | |
| | Angle of the | Sensor 1, | Sensor 2, | Sensor 3, | |
| Test | reflector to the | lower part | middle part | upper part | |
| option | membrane of | of the | of the | of the | |
| number | the humidifier | incubator | incubator | incubator | Delta |
| Option 1 | 10° . . . 30° | 36.6 | 37.0 | 38.3 | 1.7 |
| Option 2 | 30° . . . 60° | 37.7 | 37.9 | 38.0 | 0.3 |
| Option 3 | 60° . . . 90° | 37.1 | 37.8 | 38.2 | 1.1 |

As noted above in Option 1, where an angle of the reflector is within the range of 10° . . . 30°, the temperature difference is 1.7° C. In the lower part of the incubator, a cold dead-air area is formed and adversely affects temperature distribution throughout the entire volume of the incubator.

The analysis of the test results shows that the temperature difference is 0.3° C. in the three areas of the incubator. The availability of the reflector and the said location thereof allows for moving steam upwards to the level of the diffuser. Such design solution of the reflector of the humidifier allows for maintenance of a given humidity and, at the same time, provides stable temperature conditions.

The claimed small-sized incubator for eggs is easy in operation, meets present-day requirements, is characterized by a high specific load and energy efficiency, and also expands the field of its use by providing a given air temperature and humidity conditions inside the incubator in a wide range.

The present invention may be further elaborated in detail without altering its essence described in the claims section. In general, the features of the incubator being claimed are essential and are required to achieve the technical result.

The present invention is illustrated by the following exemplary embodiments and the respective figurative materials as follows:

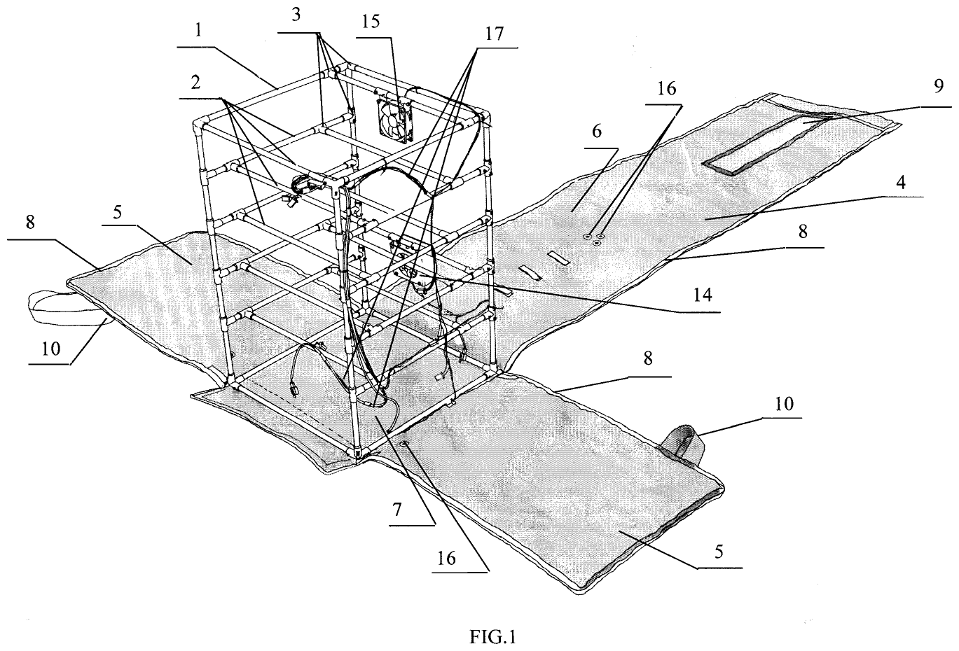

FIG. 1 is a general expanded view of the frame housing of the incubator with a fan and an emergency fan and a heat-insulating cover;

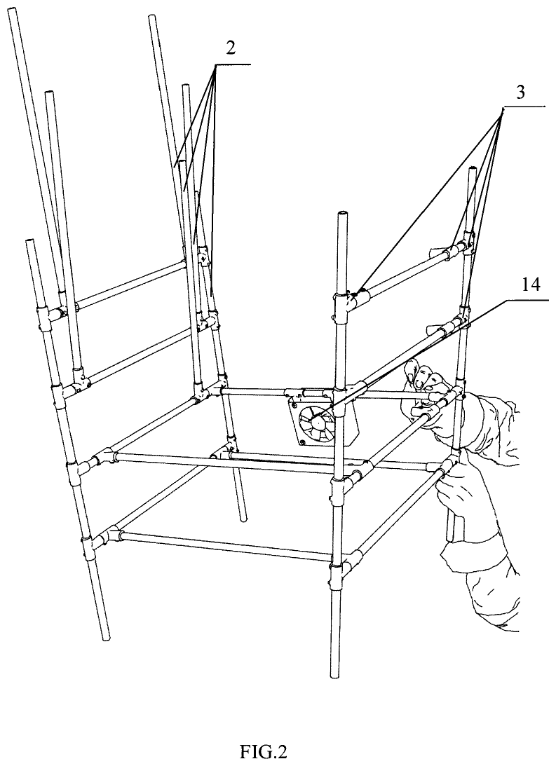

FIG. 2 shows an assembly of the frame housing;

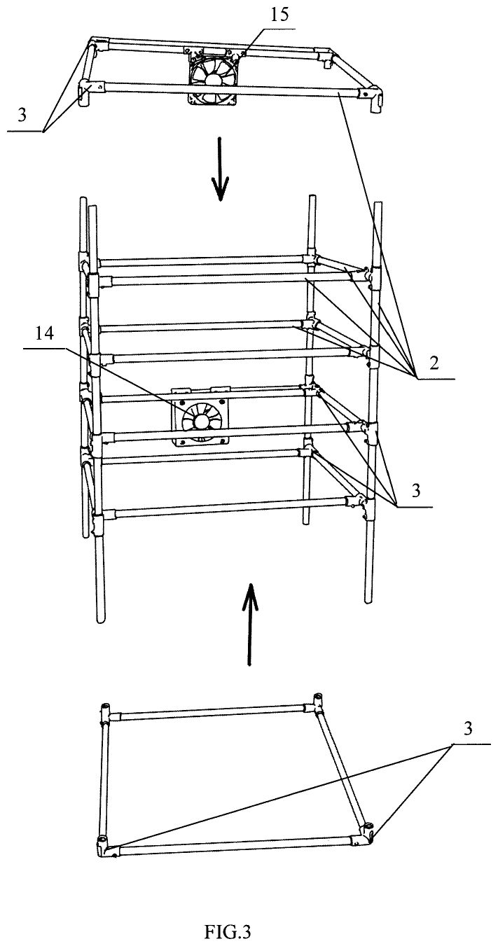

FIG. 3 is a general view of the frame housing of the incubator divided into the upper, central and lower parts;

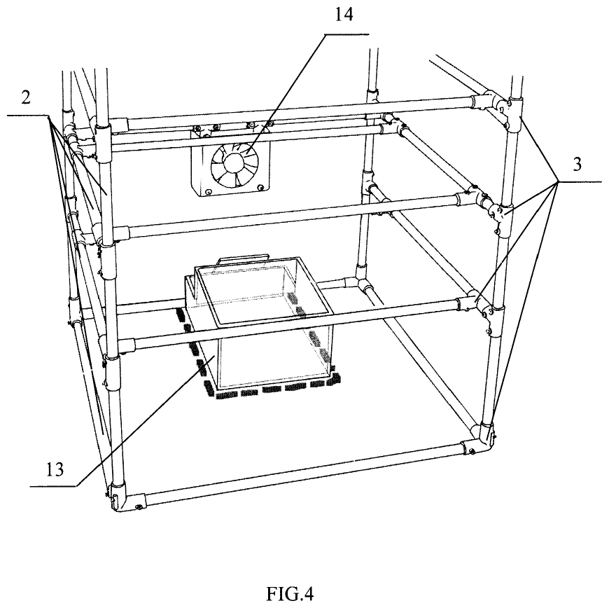

FIG. 4 is an image of a frame housing with a humidifier;

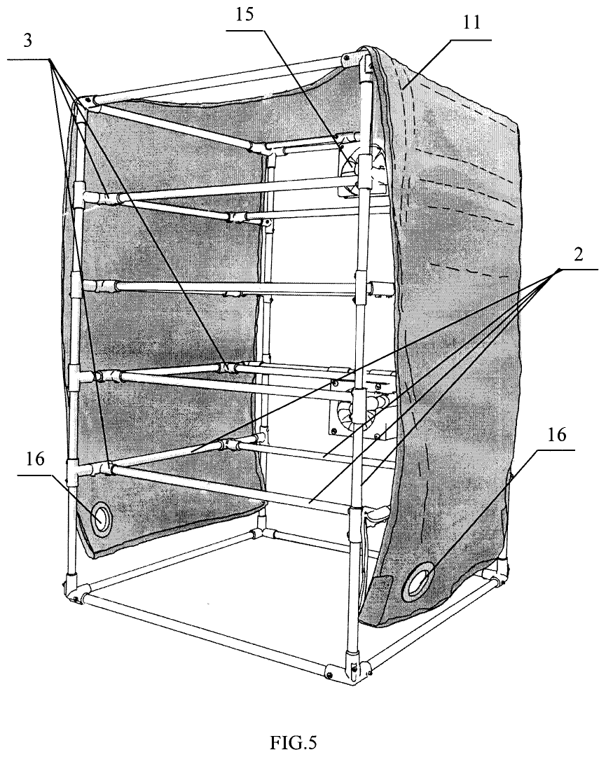

FIG. 5 is an image of a frame housing with a heating element (heating mat).

Figures that illustrate the invention disclosed herein as well as a particular embodiment of the incubator are in no way intended to limit the claims appended hereto but to explain the essence of the invention.

The small-sized incubator comprises a frame housing 1, having the form of a parallelepiped, configured to have a frame structure. The frame housing 1 consists of individual frame elements 2 configured to be solid and/or hollow and having a cylindrical shape. In some embodiments, they may have a prismatic shape. Frame elements 2, in their turn, are interconnected with connectors configured to form muff couplings 3 varying in design which ultimately fix the frame housing 1.

The small-sized incubator contains a heat-insulating cover 4, which completely covers all walls of the frame housing 1, when the incubator is in operation, and, when not in operation, unfolds to form two sidewalls 5 and one solid wall 6, being the front, the upper and the rear walls. The said walls 5 and 6 are totally connected to the bottom of the cover 7. When the incubator is in operation, the walls 5 and 6 of the cover 4 are interconnected by means of a zipper fastener 8 and a textile fastener (a Velcro fastener) (not shown in FIG). The front part of the wall 6 of the cover 4 has a vertical inspection window opening 9 made of a transparent material to allow for visual inspection of the condition of eggs. Handles 10 are located on the sidewalls 5 to easily move the incubator from place to place.

The small-sized incubator contains a heating element having the form of a heating mat 11 that is a dielectric insulated elastic cable sewn inside a fabric mat. The heating element can also be made using the design solutions known in the prior art. The heating mat 11 is located directly above the inner surface of the heat-insulating cover 4, in particular on the two sidewalls and the upper wall of the frame housing 1. In other embodiments, the heating mat may be located on the inner surface of the heat-insulating cover 4. Alternatively, there are also options for placing the heating mat 11 relative to the upper wall and/or the sidewalls of the frame housing 1, depending on the required temperature conditions.

The small-sized incubator contains a humidifier 13 which can be made using the design solutions known in the prior art. According to the second embodiment of the incubator, the humidifier 13 is configured to be a high-frequency membrane having the form of a water tank with a working area having the form of a cuvette with a high-frequency membrane placed on the bottom thereof. The humidifier 13 is also equipped with a reflector placed above the membrane at an angle of 45° to the membrane. The water tank is filled with water to maintain certain air humidity inside the incubator. The availability of water in the tank can be visually checked through the window opening 9. The air humidity inside the incubator is regulated automatically. The autonomy of the incubator is also achieved in that water should be added once every three to four days depending on the given humidity parameters.

The small-sized incubator contains a fan 14 equipped with a diffuser (not shown in FIG.) having the form of a channel which, in combination with the fan 14, is a forced airflow guide. The fan 14 is mounted to the rear inner wall of the frame housing 1 using a T-type coupling. The fan 14 with the diffuser is located directly above the humidifier 13, and the axis of the fan 14 is located at a height of 40 cm of the incubator from the lower inner surface of the heat-insulating cover 4.

The small-sized incubator is equipped with an emergency fan 15 located in the upper part of the frame housing 1, in particular on the rear inner wall. In order to notify of events occurring in case of a deviation from the pre-set parameters, additional sound signaling is provided (not shown in FIG.).

Further, the small-sized incubator is equipped with an additional fan (not shown in FIG.) located on a wall of the frame housing 1 that is opposite the fan 14 with the diffuser, in particular opposite the fan 14 with the diffuser.

The small-sized incubator is equipped with ventilation openings 16 located on the heat-insulating cover 4. As the air masses are constantly heated inside the incubator, ventilation openings 16 are made in the lower part and in the upper part of the heat-insulating cover 4 to allow for the inflow and outflow of air, respectively. In a particular embodiment, ventilation openings 16 are located on the sidewalls 5 when made in the lower part of the heat-insulating cover 4 and on the rear wall 6 when made in the upper part.

Further, the small-sized incubator comprises at least one egg tray (not shown in FIG.) configured to rotate eggs and is installed in the so-called cells of the frame housing 1 formed with the frame elements 2. The number of egg trays is determined by a user and, depending on that number, the frame housing 1 is then assembled by adding or removing frame elements 2 using connectors. In any position, egg trays do not create obstacles to the movement of air, so eggs do not overheat.

Further, the small-sized incubator is equipped with a temperature sensor and a humidity sensor located in the middle of the incubator where an egg is to be hatched.

The small-sized incubator is also equipped with a control unit (not shown in FIG.) having the form of a box with a digital display. The control unit is located on the outer side of the frame housing 1 of the incubator. As is known, it is recommended to maintain a temperature with an accuracy of up to 0.3° C. and humidity—with an accuracy of up to 5% for the egg incubation process. The control unit provides automatic operation of all elements of the incubator. In the event of an emergency shutdown of the 220V power network, an indicator on the display of the control unit informs a user that the incubator is switched to the backup power supply. The control unit provides an opportunity to change the heating capacity of the heating mat 11. A multi-stage heating system builds the algorithm of maintaining a given temperature at its own. To maintain temperature and to compensate for losses, a microcontroller located in the control unit has 255 opportunity gradations where 0 is 0% and 255 is 100%.

A loop 17 is connected to the control unit, and the said loop is attached to the frame elements 2 of the frame housing 1 by means of connectors, for example, in the form of binders. The incubation mode cannot remain constant and should be changed depending on peculiarities of embryonal development at various stages (i.e. should be differentiated by incubation phase). Using the control unit, the temperature and humidity are set in accordance with the accepted incubation technology. Once the parameters are set, the incubator operates in the automatic mode.

Further, the incubator may comprise a Wi-Fi sensor (not shown in FIG.) having the form of any Wi-Fi sensor known in the art which allows for control, and subsequently, manage the parameters of the incubator.

In the event of a power failure, the small-sized incubator can automatically switch on the backup power supply having the form of any battery (not shown in FIG.) known in the art. Once network voltage is available again, the incubator automatically switches to the stationary source of power supply, and the battery is charged from the network. This ensures the operation of the incubator in an automatic mode.

The incubator equipped with an emergency system and configured so that it is low-voltage and can be operated from a backup power supply provides safety of operation.

Further, the small-sized incubator comprises a LED strip (not shown in FIG.) located on the rear wall of the incubator. To ensure the energy efficient operation of the incubator, the light inside the incubator is activated by a user pressing a button on a front panel of the control unit.

The small-sized incubator works as follows.

First, the frame housing 1 having the form of a parallelepiped is assembled by installing the frame elements 2 in fitment holes varying in design of the muff couplings 3. The frame elements 2 of the bottom and the upper part of the frame housing 1 can be assembled separately and can be ultimately fastened to the main part of the frame housing 1. Further, the frame elements 2 are then installed between the walls of the frame housing 1 to form the so-called cells for egg trays.

The assembled frame housing 1 is then placed on the bottom of the heat-insulating cover 4 as shown in FIG. 1. The fan 14 with the diffuser with the axis located at a height of 40 cm of the incubator from the lower inner surface of the insulating cover 4 is then installed on the rear inner wall of the frame housing 1. Next, the emergency fan 15 is installed in the upper part of the frame housing 1 on the rear inner wall.

The humidifier 13 is then filled with water and placed on the bottom of the heat-insulating cover 4. The loop 17 is fixed with binders on the frame elements 2 of the frame housing 1. Next, the heating mat 11 which covers the upper wall and sidewalls of the frame housing 1 is freely installed on top of the frame housing 1.

Eggs are then loaded onto egg trays and egg trays are installed in the so-called cells of the frame housing 1 one by one. The number of trays is determined by a user, and the frame housing 1 is assembled based on that number by adding or removing the frame elements 2 using connectors. Next, the loop 17 is connected to the main elements of the incubator operation: the humidifier 13, the temperature sensor, egg trays to be connected one by one, the fan 14 with the diffuser, the emergency fan 15, and the LED strip. If the ambient temperature is low (not lower than 10° C.), the additional fan is connected.

Next, the heat-insulating cover 4 with the frame housing 1 and the above mentioned elements of the incubator are completely closed using the zipper fastener 8 and the textile fastener (Velcro fastener). The loop 17 is then connected to the control unit. The incubator is connected to the mains with a power cable (not shown in FIG.). The incubator works. If the power supply is disconnected, the incubator connects to the backup power supply to ensure an uninterrupted process of egg incubation independent of power failures.

The required temperature and humidity conditions are set in the incubator using the control unit. Water in the form of fog for wetting is sprayed and taken up by airflow with the help of the fan 14 with the diffuser located directly above the humidifier 13 and is evenly distributed throughout the volume of the incubator. The air inside the incubator is circulated using the fan 14 with the diffuser. Ventilation openings 16 provide natural convection of airflows inside the incubator: external oxygen-enriched air enters the incubator, while exhaust air saturated with carbon dioxide comes out of the incubator. In the event of a deviation from the pre-set temperature parameters, for example, when eggs produce more heat during the final days of the incubation process, the emergency ventilator 15 automatically cools the air inside the incubator by blowing the overheated air out of the incubator. Thus, when a temperature increases above the required normal value, the overheated air is removed with the help of the emergency fan 15. To notify of events occurring in case of a deviation from the pre-set parameters, the sound signaling is activated.

During the operation of the incubator, the basic temperature and humidity parameters are subject to control, while the condition of eggs is subject to visual inspection using the vertical inspection window opening 9. After the completion of the incubation process, the small-sized incubator is completely disassembled, with all disassembled structural elements are subject to thorough cleaning, disinfection, and the heat-insulating cover 4 can also be washed. Although characterized by structural simplicity, the present invention can increase the hatchability rate. A sample incubator made according to the present invention has been studied and tested, and the said studies and tests confirmed performance of the incubator and the expected technical result.

Thus, the application of the present invention allows us to create an energy-efficient small-sized incubator characterized by highly-reliable operation in a given range of air temperature and humidity by positioning heating, ventilation and humidification elements in the design of the incubator and, at the same time, by improving the ease of its operation and providing an opportunity for thorough cleaning by configuring the housing and the heat-insulating cover of the incubator so that the said elements are made assemblable and disassemblable.

1. A small-sized incubator comprising a housing, preferably having the form of a parallelepiped, configured to have a frame structure; a heat-insulating cover, a heating element, a humidifier, a fan, at least one egg tray configured to rotate eggs, a temperature sensor and a humidity sensor, a control unit configured to be connected to a backup power unit, wherein the frame housing is configured to be assembled and disassembled with connectors; the heating element is located on or directly above the inner surface of the heat-insulating cover; the incubator is equipped with an emergency fan located on the top of the housing.

2. The small-sized incubator of claim 1 wherein the heating element is positioned in the upper and/or side parts of the housing.

3. The small-sized incubator of claim 1 wherein the heating element is configured so that heating capacity can be changed.

4. The small-sized incubator of claim 1 wherein the heating element is configured to form a heating mat.

5. The small-sized incubator of claim 1 wherein the axis of the fan is located at a distance of up to 0.5 of the height of the incubator from the lower inner surface of the heat-insulating cover.

6. The small-sized incubator of claim 1 wherein the fan is equipped with a diffuser located directly above the humidifier.

7. The small-sized incubator of claim 1 wherein the small-sized incubator is equipped with an additional fan located on a wall of the frame housing that is opposite the fan with a diffuser.

8. The small-sized incubator of claim 1 wherein the small-sized incubator is equipped with ventilation openings located on a heat-insulating cover.

9. A small-sized incubator comprising a housing, preferably having the form of a parallelepiped, configured to form a frame structure; a heat-insulating cover, a heating element, a humidifier, a fan, at least one egg tray configured to rotate eggs, a temperature sensor and a humidity sensor, a control unit configured to be connected to a backup power source, wherein the frame housing is configured to be assembled and disassembled with connectors; the heating element is placed on or directly above the inner surface of the heat-insulating cover; the humidifier is configured to be a high-frequency membrane equipped with a reflector.

10. The small-sized incubator of claim 9 wherein the reflector is located above the membrane at an angle of 30° to 60° to the membrane.

11. The small-sized incubator of claim 9 wherein the heating element is positioned in the upper and/or side parts of the housing.

12. The small-sized incubator of claim 9 wherein the heating element is configured to change the heating capacity.

13. The small-sized incubator of claim 9 wherein the heating element is configured to form a heating mat.

14. The small-sized incubator of claim 9 wherein the axis of the fan is located at a distance of up to 0.5 of the height of the incubator from the lower inner surface of the heat-insulating cover.

15. The small-sized incubator of claim 9 wherein the fan is equipped with a diffuser located directly above the humidifier.

16. The small-sized incubator of claim 9 wherein the small-sized incubator is equipped with an emergency fan located in the upper part of the housing.

17. The small-sized incubator of claim 9 wherein the small-sized incubator is equipped with an additional fan located on a wall of the frame housing opposite the fan with a diffuser.

18. The small-sized incubator of claim 9 wherein the small-sized incubator is equipped with ventilation openings located on a heat-insulating cover.
